(19) United States
(12) Patent Application Publication
(10) Pub. No.: US 2006/0269304 A1
(43) Pub. Date: Nov. 30, 2006

(54) Image forming apparatus

(75) Inventors: Youbao Peng, Tokyo (JP); Atsushi Takahashi, Tokyo (JP); Yoshihito Sasamoto, Tokyo (JP); Takashi Nara, Niiza-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/339,560

(22) Filed: Jan. 26, 2006

(30) Foreign Application Priority Data
May 27, 2005 (JP) JP2005-155346

(51) Int. Cl. G03G 15/20

(52) U.S. Cl. 399/33; 399/69; 399/70; 399/88

(57) ABSTRACT

The maximum available power is supplied to an electromagnetic induction heater by an electric power controller during the warm-up period from the ON-operation of the power supply to the activation of image formation mode, or during the recovery period from the occurrence of a trouble to the recovery for enabling image formation.

### BACKGROUND

1. Field of the Invention

The present invention relates to an image forming apparatus for-forming an image on a recording material.

2. Description of the Related Art

When image data is to be printed out by the image forming apparatus of a laser printer and copying machine, a toner image is developed on a photoconductor based on the image data and the toner image is transferred onto the recording material such as paper. An image is formed on the recording material when heat and pressure are given by a fixing device. Heating by the fixing device requires a predetermined time. Accordingly, in the prior art, proposals have been made to reduce the time required to permit an image to be formed. For example, these proposals are disclosed in Japanese Unexamined Patent Publication No. 2003-345149 (Patent Document 1), Japanese Unexamined Patent Publication No. 2002-278381 (Patent Document 2) and Japanese Unexamined Patent Publication No. 7-110637 (Patent Document 3).

However, the image forming apparatus described in the Patent Documents 1 through 3 uses the method of merely adjusting the electric power supplied to the fixing device in response to the form of loaded operations during the image forming operation. These Patent Documents do not give consideration to a warm-up period required from turning on of power supply to image formation, or the time of recovery from the occurrence of paper jam, open/close operation of the door, or the trouble caused by a staple and paper left behind. These Patent Documents fail to solve the problem of reducing the time required for image formation.

Thus, there is an active demand for an image forming apparatus capable of cutting down the time required after warming up or-recovery from failure.

### SUMMARY

The present invention provides an image forming apparatus having a fixing device to fix a toner image on a recording material; an electric power source to supply to an electric power; an electromagnetic induction heater, to which an electric power is supplied from the electric power source, to heat the fixing device by electromagnetic induction heating; a starting controller to control starting of the image forming apparatus; and a power supply controller which supplies available electric power from the power electric power source to the heater during the starting time of the image forming apparatus.

Another aspect of the present invention provides an image forming apparatus comprising: a fixing device for fixing a toner image formed on a recording material; an electric power source to supply to an electric power; an electromagnetic induction heater for heating the fixing device through electromagnetic induction heating, using the electric power supplied from the electric power source; a temperature detector for detecting the temperature of the fixing device; a document reader; and a power supply controller for suspending the image forming operation and the document reader operation, before the temperature of the fixing device having been reduced by jamming reaches a predetermined level that allows normal fixing of the toner image, wherein the power supply controller supplies the electromagnetic induction heater with the maximum electric power that can be supplied from the electric power source.

Another aspect of the present invention provides An image forming apparatus comprising: a fixing device for fixing a toner image formed on a recording material; an electric power source to supply to an electric power; an electromagnetic induction heater for heating said fixing device through electromagnetic induction heating, using the electric power supplied from the electric power source; a temperature detector for detecting the temperature of said fixing device; a document reader; a determining section for determining whether or not the temperature detected by the temperature detector has reached the fixing alarm generation temperature that disables the toner image fixing operation; and a power supply controller that, when said determining section has determined that the temperature detected by the temperature detector has reached the fixing alarm generation temperature, suspends the image forming operation and the document reader operation, before the temperature of said fixing device having been detected by said temperature detector reaches a predetermined temperature that allows normal fixing of said toner image, wherein said power supply controller supplies the electromagnetic induction heater with the maximum electric power that can be supplied from the electric power source.

The invention itself, together with further objects and attendant advantages, will best be understood by reference to the following detailed description taken in conjunction with the accompanying drawings.

### BRIEF DESCRIPTION OF THE DRAWINGS

FIG. 1 is a diagram representing an example of the temperature control circuit of an image forming apparatus;

FIG. 2 is a flow chart representing the processing of electric power control during the warm-up period;

FIG. 3 is a flow chart representing an example of electric power control sequence during the warm-up period;

FIG. 4 is a flow chart representing the processing of electric power control at the time of recovery from paper jam;

FIG. 5 is a flow chart representing the processing of electric power control at the time of recovery from occurrence of fixing alarm; and

FIG. 6 is a flow chart representing the processing of electric power control when a symptom of the occurrence of fixing alarm has been confirmed.

In the following description, like parts are designated by like reference numbers throughout the several drawings.

### DESCRIPTION OF THE PREFERRED EMBODIMENT

The following describes the details of the best form of embodiment of the present invention with reference to the drawing, without the present invention being restricted thereto.

[Embodiment 1]

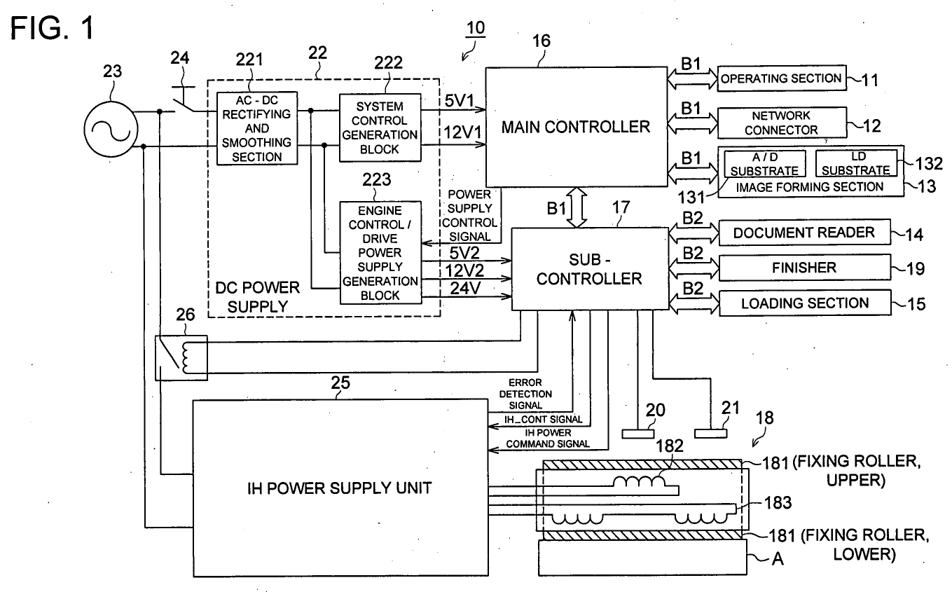

Referring to FIG. 1, the following describes the structure of the image forming apparatus 10.

FIG. 1 is a diagram representing an example of the temperature control circuit of an image forming apparatus 10 including the fixing device using the electromagnetic induction heater as a heater, wherein heating is provided by electromagnetic induction.

In FIG. 1, the image forming apparatus 10 includes an operating section 11, network connector 12, image forming section 13, document reader 14, loading section 15, main controller 16, sub-controller 17, fixing device 18 and finisher 19.

The operating section 11 is designed to instruct the operations of the image forming apparatus 10, and is provided with an operation input key and display screen, for example. The operation input key is structured to input the settings and the operation instruction of the image forming apparatus 10. It is represented by the operation button and remote control device, for example. The display screen is made of an LCD (liquid crystal display), for example, and is designed to display the settings and operation statuses of the image forming apparatus. When the operating section 11 is a touch panel, the display screen also serves as the operation input key.

The network connector 12 is provided with a communication interface such as a network interface card (NIC) and modem, and is used to exchange data with other devices connected on the Internet.

The image forming section 13 contains an A/D substrate 131 for analog-to-digital (A/D) conversion of the image data having been inputted from the main controller 16 and an LD (Laser Diode) 132 for forming the image data having been converted, as an electrostatic latent image onto the image carrier such as a photoconductor (not illustrated)

The document reader 14 is a functional section for reading the secondary information of the document placed on a document platen and converting it into the digital data. To be more specific, the document reader 14 applies light to the document placed on the document, reads the reflected light from the CCD, converts it into the linear digital data, and output it to the sub-controller 17.

The loading section 15 is made up of a plurality of circuits and mechanisms for image forming processes such as copying operation by the image forming apparatus 10. For example, it contains a motor for driving the fixing roller 181 of the fixing device 18 and the pressure rotor (not illustrated), a control circuit for controlling this motor, a conveyance mechanism for conveying such a recording material as paper from the pressure rotor (not illustrated, and a control circuit for controlling this mechanism.

The main controller 16 includes a CPU (Central Processing Unit), a ROM (Read Only Memory) and a RAM (Random Access Memory). The main controller 16 reads and executes various settings and system programs stored in the ROM and others, thereby providing administrative control of the entire image forming apparatus 10 through the bus B1. To put it more specifically, the main controller 16 provides system-related control such as control of the mother board of the image forming apparatus, image control, and control of the printer controller. For example, the main controller 16 controls startup processing of various sections at the time of startup (bootup), and recovery processing in the event of a failure such as paper jam.

The sub-controller 17 is made up of a CPU, ROM, RAM and others. It reads and executes various settings and system programs stored in the ROM and others, thereby controlling the operations of the document reader 14, loading section 15 and finisher 19 through the bus B2.

To detect the surface temperature of the fixing roller 181, the fixing device 18 is provided with two non-contact type sensors; a first temperature sensor 20 for detecting the temperature of the heat radiated from the center of the fixing roller 181, and a second temperature sensor 21 for detecting the temperature radiated from the end of the fixing roller 181. The first temperature sensor 20 is located on the top of the fixing roller 181 to detect the temperature at the center of the fixing roller 181. The second temperature sensor 21 is located on the top of the fixing roller 181 to detect the temperature at the ends of the fixing roller 181. A resistance temperature sensor (e.g. thermister) can be used as the first temperature sensor 20 and second temperature sensor 21.

The sub-controller 17 allows the power supply controller and determining section to be implemented through collaboration between the temperature T at the center and ends of the fixing roller 181 inputted from the first temperature sensor 20 and second temperature sensor 21, and the system program stored in the storage section of the ROM and others. In this case, the temperature T at the center and ends of the fixing roller 181 inputted from the first temperature sensor 20 and second temperature sensor 21 can be the temperature inputted from either one of the temperature sensors or the average value of the temperatures implemented from both of these sensors.

The fixing device 18 is provided with a fixing roller 181 for fixing the toner formed on the recording material A, a first heater 182 and second heater 183 for heating the fixing roller 181 by electromagnetic induction using the power supplied from the IH power supply unit 25, and a pressure roller as a pressure member for forming a fixing nip by coming in contact with the fixing roller 181.

As shown in FIG. 1, the first heater 182 heats the center of the fixing roller 181 and second heater 183 heats the ends of the fixing roller 181. As the electric power supplied to the fixing device 18 from the IH power supply unit 25 is supplied by the sub-controller 17, the heating temperature by the first heater 182 and second heater 183 is controlled. The first heater 182 and second heater 183 are provided with alternate on-off control by the IH power supply unit 25, whereby the heating operation is performed alternately by these two heaters.

The fixing roller 181 is driven by a drive source (not illustrated), and the pressure roller is driven by the fixing roller 181. The fixing roller 181 and the pressure roller applies heat and pressure to the recording material A while being conveyed sandwiched by the fixing nip. Thus, the toner image on the recording material A is molten and fixed in position.

The finisher 19 is controlled by the sub-controller 17. In response to the request for finishing, the finisher 19 applies a predetermined finishing processes such as punching, stapling and folding to the copied objects supplied to the ejection tray and image forming section. Then the copied objects are ejected to the ejection tray.

The DC power supply 22 receives AC power from the AC power supply 23, and supplies power to each section of the image forming apparatus 10, based on the power control signal of the main controller 16. The on-off control of the DC power supply 22 is provided by the operator performing the on-off operation of the power switch SW 24. The DC-power supply 22 incorporates an AC-DC rectifying and smoothing section 221 for converting the AC power received from the AC power supply 23, into DC power, and for rectifying and smoothing the resulting DC power; a system control power supply generating block 222 for supplying the main controller 16 with the power received from the AC-DC rectifying and smoothing section 221; and an engine control/drive power supply generation block 223 for supplying the sub-controller 17 with the power from the AC-DC rectifying-and smoothing section 221. The engine control/drive power supply generation block 223 supplies power to the sub-controller 17 in response to the power control signal.

The IH power supply unit 25 receives AC power from the AC power supply 23, and supplies it to the first heater 182 and second heater 183, based on the control signal (IH power command signal, IH_CONT signal) of the sub-controller 17. The IH power supply unit 25 provides on/off control alternately to the first heater 182 and second heater 183 of the fixing device 18. This arrangement allows the entire portion of the fixing roller 181 to be heated uniformly, and eliminates the need of distributing power to the first heater 182 and second heater 183.

The sub-controller 17 for supplying the IH power supply unit 25 with the AC power supply 23 from the AC power supply 23 sends the relay off signal for instructing suspension of power supply to the relay circuit 26, in the event of temperature failure wherein the temperature detected by the first temperature sensor 20 and second temperature sensor 21 has exceeded a predetermined temperature or on receipt of an error detection signal from the IH power supply unit 25, whereby the relay circuit 26 suspends power supply to the IH power supply unit 25.

The following describes the control of power supplied to the fixing device 18, with reference to the aforementioned structure:

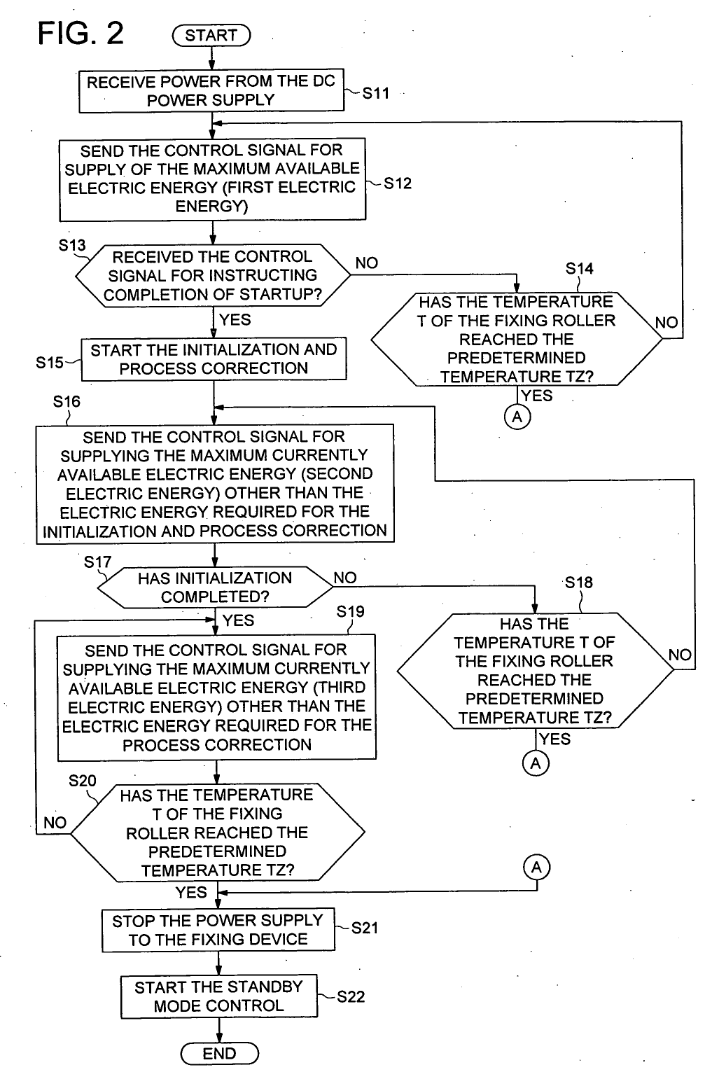

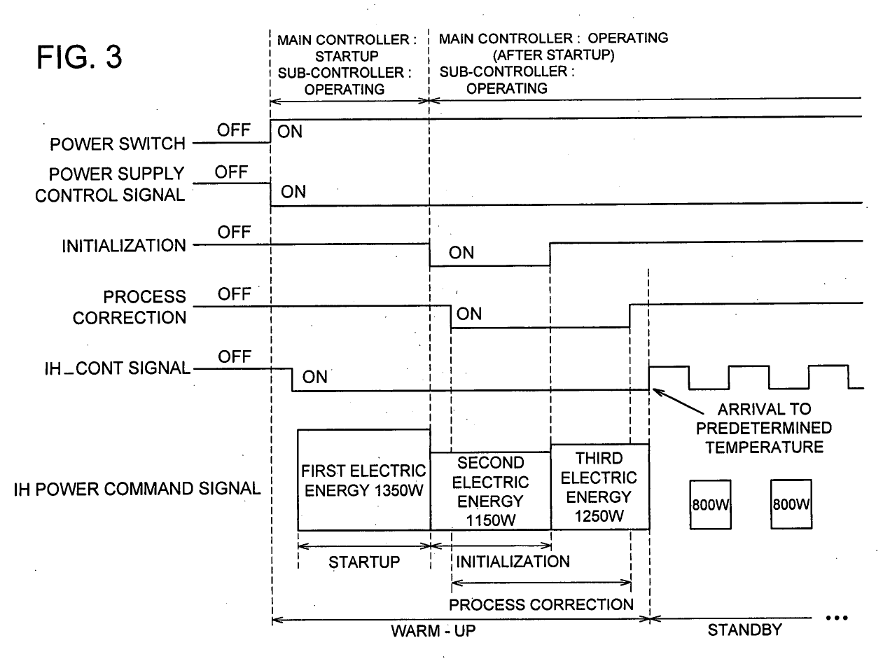

Referring to FIGS. 2 and 3, the drawings, the following describes the power control at the time of warm-up operations when the image forming apparatus 10 is started.

FIG. 2 is a flow chart representing the processing of electric power control during the warm-up period. The processing applied in FIG. 2 indicates the processing carried out by the sub-controller 17.

The power switch SW 24 is turned on. Then the system related to the image forming apparatus 10 is started by the main controller 16. When power is supplied to the engine control/drive power supply generation block 223 based on the power control signal (Step S11), then the control signal (IH_CONT signal, IH power command signal) for allowing the maximum currently available electric energy (hereinafter referred to as “first electric energy”) to be supplied is. sent to the IH power supply unit 25 (Step S12). The power in response to this control signal is supplied to the fixing device 18 from the IH power supply unit 25.

Then a decision step is taken to check for the reception of the control signal that indicates completion of the startup of the image forming apparatus 10. If it is determined that this control signal has not been received (NO in Step S13), a decision is made to determine whether or-not the temperature T of the fixing roller 181 of the fixing device 18 has reached a predetermined temperature TZ. If it is determined that the predetermined temperature TZ has been reached (YES in Step S14), the system proceeds to Step S21. If it is determined that the predetermined temperature TZ has not yet been reached (NO in Step S14), the system goes back to Step S11; The predetermined temperature TZ refers to the temperature suited to fix a toner image on the recording material, and is set in response to the characteristics of the recording material.

When it is determined in Step S13 that the signal indicating completion of the start of the image forming apparatus 10 has been received (YES in Step S13), initialization of various sections of the image forming apparatus 10 such as the loading section 15, and processing related to process correction such as color registration correction for ensuring image stability, and correction of toner density are carried out (Step S15). The initialization and process correction can be carried out by either the sub-controller 17 or main controller 16. Alternatively, they can be carried out through collaboration between the main controller 16 and sub-controller 17.

The control signal for supplying the IH power supply unit 25 with the maximum currently available electric energy (hereinafter referred to as “second electric energy”) other than the electric energy required for the initialization and process correction (Step S16).

This is followed by the decision step of determining whether or not initialization has been completed. If it is determined that the initialization has not been completed (NO in Step S17), a decision is made to determine whether or not the temperature T of the fixing roller 181 of the fixing device 18 has reached the predetermined temperature TZ. If it is determined that the predetermined temperature TZ has been reached (YES in Step S18), the system proceeds to Step S21. If it is determined that the predetermined temperature TZ has not yet been reached (NO in Step S18), the system goes back to Step S16.

If it is determined in Step S17 that initialization has completed (YES in Step S17), the control signal for supplying the maximum currently available electric energy (hereinafter referred to as “third electric energy”) other than the electric energy required for process correction is supplied to the IH power supply unit 25 (Step S19).

A decision step is taken to determine whether or not the temperature T of the fixing roller 181 of the fixing device 18 has reached a predetermined temperature TZ. If it is determined that the predetermined temperature TZ has not been reached (NO in Step S20), the system goes back to Step S19. If it is determined that the predetermined temperature TZ has been reached (YES in Step S20), the system goes back to Step S21.

In Step S21, the control signal for suspending the power supply to the fixing device 18 is sent to the IH power supply unit 25, and the power supply is suspended (Step S21). Then the system goes to the standby mode wherein the signal. for supplying a predetermined power energy is sent to the IH power supply unit 25 on an intermittent basis (Step S22). This will terminate the present processing.

FIG. 3 is a flow chart representing an example of electric power control sequence during the warm-up period. As shown in FIG. 3, when the power switch SW 24 is turned on, power is supplied to the main controller 16 and power supply control signal for the supply of power to the engine control/drive power supply generation block 223 is turned on by the main controller 16. When the power is supplied to the sub-controller 17, the signal IH_CONT signal for starting the supply of power to the fixing device 18 as the control signal is sent to the IH power supply unit 25 from the sub-controller 17. Then the first electric energy as the maximum currently available electric energy (e.g. 1350 W) is sent to the fixing device 18 during the startup operation of the main controller 16.

While initialization and process correction are carried out (while they are on) after completion of the startup operation of the main controller 16, the second electric energy as the maximum currently available-electric energy other than the electric energy required for the initialization and process correction (e.g. 1150 W) is supplied to the fixing device 18. After completion of initialization, the third electric energy as the maximum currently available electric energy other than the electric energy required for the process correction (e.g. 1250 W) is supplied to the fixing device 18.

FIG. 3 shows an example wherein the predetermined temperature TZ is reached during the supply of the third electric energy. Upon arrival to the predetermined target temperature TZ, the control signal for turning off the IH_CONT signal is sent to the IH power supply unit 25 and the supply of power to the fixing device 18 is stopped. After that, the system goes to the standby mode wherein the signal for supplying a predetermined power energy (e.g. 800 W) to the fixing device 18 is sent to the IH power supply unit 25 on an intermittent basis.

As described above, the maximum available power is supplied to the fixing device 18 by the sub-controller 17 during the warm-up period from the ON-operation of the power supply to the activation of image formation mode. This arrangement reduces the time for activation of the image formation mode.

In the aforementioned processing of power control, the third electric energy is continuously supplied to the fixing device 18 until the predetermined temperature is reached. It is also possible to make such arrangements that the control signal for supplying the maximum currently available electric energy to the fixing device 18 in this phase is sent to the fixing device 18, after completion of process correction has been confirmed.

The intermittent interval wherein the electric power supplied in the standby mode and the control signal are sent can be set as desired, but is preferably set so as to maintain the predetermined temperature.

In the present embodiment, the maximum available power is supplied to the electromagnetic induction heater by the electric power controller during the warm-up period from the ON-operation of the power supply to the activation of image formation mode. This arrangement reduces the time for activation of the image formation mode.

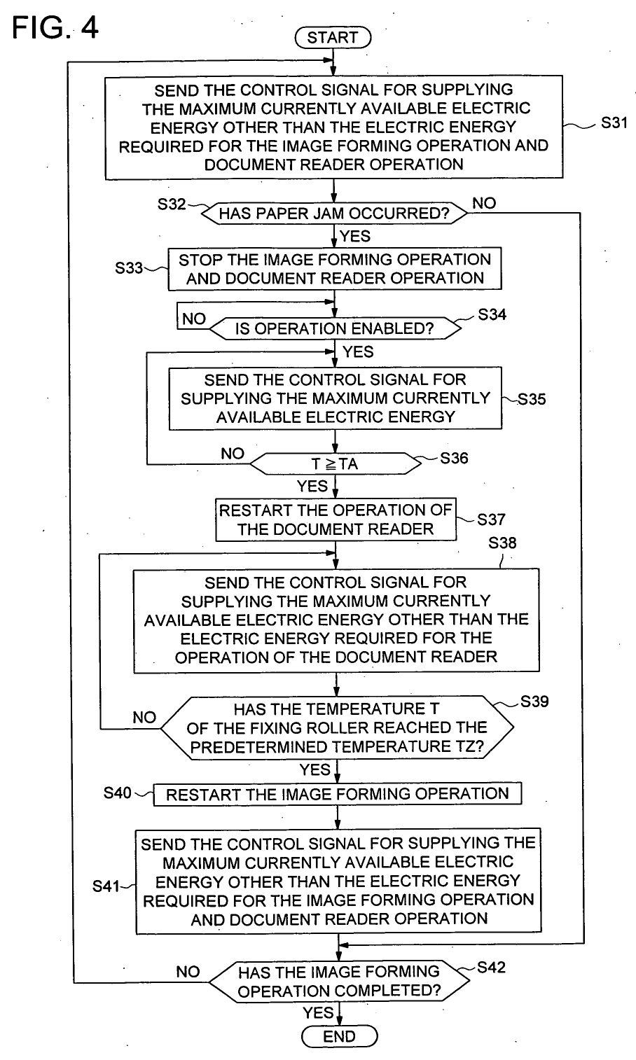

The following describes the power control for recovery from paper jam, with reference to FIG. 4.

FIG. 4 is a flow chart representing the processing of electric power control at the time of recovery from paper jam. The processing given in FIG. 4 is performed by the sub-controller 17. It is assumed that this processing starts from the standby mode shown in FIG. 2.

The document is scanned by the document reader 14 and an instruction is given by the operating section 11 to perform such operations as taking a copy (hereinafter referred to as “image forming operation”). Then the control signal for supplying the fixing device 18 with the maximum currently available electric energy other than the electric energy required for the image forming operation and document reader operation (e.g. 900 W) is sent to the IH power supply unit 25 (Step S31). The power in response to this control signal is supplied to the fixing device 18 from the IH power supply unit 25.

A decision step is taken to determine whether or not paper jam has occurred. If it is determined that it has not occurred (NO in Step S32), the system goes to Step S43.

If it is determined in Step S32 that jam has occurred (YES in Step S32), the image forming operation and document reader operation are stopped (Step S33), and the paper tray (not illustrated) is opened by the operator so that the paper is removed. After that, the paper tray is closed again, and the system is made to wait until the operation enable mode is activated (NO in Step S34).

If it is determined that the operation enable mode has been activated, (YES in Step S34), the control signal for supplying the maximum currently available electric energy (e.g. 1200 W) is sent to the IH power supply unit 25 (Step S35).

A decision step is taken to determine whether or not the temperature T of the fixing roller of the fixing device 18 has reached a predetermined level TA. If it is determined that the predetermined level T has not yet reached (NO in Step S36), the system goes to Step S35. Here it is assumed that the relationship between the temperature TA and predetermined temperature TZ is expressed by TA<TZ.

If it is determined in Step S36 that the predetermined level TA has been reached (YES in Step S36), the scanning operation of the document reader 14 starts again (Step S37). The control signal for supplying the maximum currently available electric energy other than the electric energy required for the operation of the document reader 14 (e.g. 1100 W) is sent to the IH power supply unit 25 (Step S38).

A decision step is taken to determine whether or not the temperature T of the fixing roller of the fixing device 18 has reached a predetermined level TZ. If it is determined that the predetermined level T has not yet reached (NO in Step S39), the system goes back to Step S38.

If it is determined in Step S40 that the predetermined level TZ has been reached (YES in Step S39), the image forming operation starts again (Step S40). The control signal for supplying the maximum currently available electric energy other than the electric energy required for the image forming operation and document reader operation (e.g. 900 W) is sent to the IH power supply unit 25 (Step S41).

A decision step is taken to determine whether or not image forming operation has completed. If it is determined that it has not completed (NO in Step S42), the system goes back to Step S31. If it is determined that image forming operation has completed (YES in Step S42), the present processing completes.

As described above, during the time period from paper jam to the recovery to activation of the image formation mode where correct fixing of a toner image on the recording material A is enabled, the maximum available electric energy is supplied to the fixing device 18 by the sub-controller 17. This arrangement reduces the time for activation of the image formation mode. The image forming operation and the operation of the document reader 14 are stopped by the electric power supply controller. This allows the electric energy for image forming operation and the operation of the document reader to be supplied to the fixing device 18, and prevents an image from being formed under abnormal conditions.

In the present embodiment, during the time period from paper jam to the recovery to activation of the image formation mode where correct fixing of a toner image on the recording material is enabled, the maximum available electric energy is supplied to the electromagnetic induction heater by the electric power supply controller. This arrangement reduces the time for activation of the image formation mode. The image forming operation and the document reader operation are stopped by the electric power supply controller. This allows the electric energy for image forming operation and the document reader operation to be supplied to the electric power supply controller, and prevents an image from being formed under abnormal conditions.

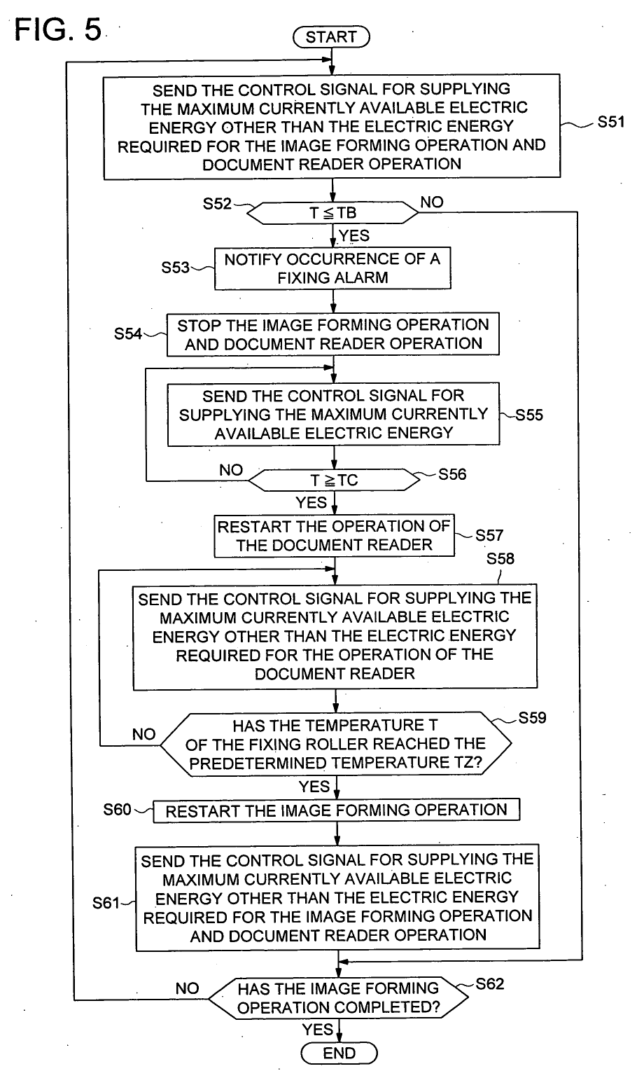

Referring to FIG. 5, the following describes the electric power control at the time of recovery from the occurrence of fixing alarm. The occurrence of fixing alarm means that the temperature of the fixing roller 181 has deviated from the normal temperature to reach the point (hereinafter referred to as “fixing alarm temperature TB”) where normal fusing is disabled. The fixing alarm occurs, for example, when much time is required to solve the jamming problem or the door of the image forming apparatus is kept open beyond a predetermined period of time. Here it is assumed that the relationship between the fixing alarm temperature TB and predetermined temperature TZ is expressed by TB<TZ.

FIG. 5 is a flow chart representing the processing of electric power control at the time of recovery from occurrence of fixing alarm. The processing given in FIG. 5 is performed by the sub-controller 17. It is assumed that this processing starts from the standby mode shown in FIG. 2.

The document is scanned by the document reader 14 and an instruction is given by the operating section 11 to perform such operations as taking a copy (hereinafter referred to as “image forming operation”). Then the control signal for supplying the fixing device 18 with the maximum currently available electric energy other than the electric energy required for the image forming operation and document reader operation (e.g. 900 W) is sent to the IH power supply unit 25 (Step S51). The power in response to this control signal is supplied to the fixing device 18 from the IH power supply unit 25.

A decision step is taken to determine whether or not the temperature T of the fixing roller 181 is below the fixing alarm temperature TB. If it is determined that it is above the fixing alarm temperature TB, (NO in Step S52), the system goes to Step S62.

If it is determined in Step S52 that the temperature T of the fixing roller 181 is below the fixing alarm temperature TB (YES in Step S52), the display screen of the operating section 11 shows the message to notify that fixing alarm has occurred (Step S53). Image forming operation and the operation of the document reader 14 are stopped (Step S54).

Then the control signal for supplying the maximum currently available electric energy (e.g. 1200 W) is sent to the IH power supply unit 25 (Step S55).

This is followed by the decision step of determining whether or not the temperature T of the fixing roller 181 has reached the predetermined temperature TC. If it is determined that the predetermined temperature TC has not been reached (NO in Step S56), the system goes back to Step S56. Here it is assumed that the relationship between the fixing alarm temperature TB and temperature TC is expressed by TC<TB.

If it is determined in Step S56 that the temperature TC has been reached. (YES in Step S56), the scanning operation of the document reader 14 restarts (Step S57), and the control signal for supplying the maximum currently available electric energy other than the electric energy required for the scanning operation of the document reader 14 is sent to the IH power supply unit 25 (Step S58).

A decision step is taken to determined whether or not the temperature T of the fixing device 18 has reached the predetermined temperature TZ. If it is determined that it has not yet reached the predetermined temperature TZ (NO in Step S59), the system goes back to the step S58.

If it is determined in Step S59 that the predetermined temperature TZ has been reached (YES in Step S59), the image forming operation restarts (Step S60), and the control signal for supplying the maximum currently available electric energy other than the electric energy required for the image forming operation and scanning operation of the document reader 14 (e.g. 900 W) is sent to the IH power supply unit 25 (Step S61).

A decision step is taken to determined whether or not image formation has completed. If it is determined that image formation has not yet completed (NO in Step S62), the system goes back to the step S51. If it is determined that image formation has completed (YES in Step S62), the present processing completes.

As described above, during the time period from occurrence of fixing alarm to the recovery to activation of the image formation mode where correct fixing of a toner image on the recording material A is enabled, the maximum available electric energy is supplied to the fixing device 18 by the sub-controller 17. This arrangement reduces the time for activation of the image formation mode. The image forming operation and the operation of the document reader 14 are stopped by the electric power supply controller. This allows the electric energy for image forming operation and the operation of the document reader to be supplied to the fixing device 18, and prevents an image from being formed under abnormal conditions.

In the present embodiment, during the time period from occurrence of fixing alarm to the recovery to activation of the image formation mode where correct fixing of a toner image on the recording material A is enabled, the maximum available electric energy is supplied to the electromagnetic induction heater by the electric power supply controller. This arrangement reduces the time for activation of the image formation mode. Since the image forming operation and the operation of the document reader are stopped by the electric power supply controller, the electric energy for image forming operation and the operation of the document reader can be supplied to the electromagnetic induction heater. This prevents an image from being formed under abnormal conditions.

[Embodiment 2]

The second embodiment of the image forming apparatus 10 will be described. In the first place, the following describes the electric power control wherein a symptom of the occurrence of fixing alarm has been confirmed in the second embodiment. In the following description, the same portions as the aforementioned first embodiment will be assigned with the same numerals of reference, and their details will not be described to avoid duplication.

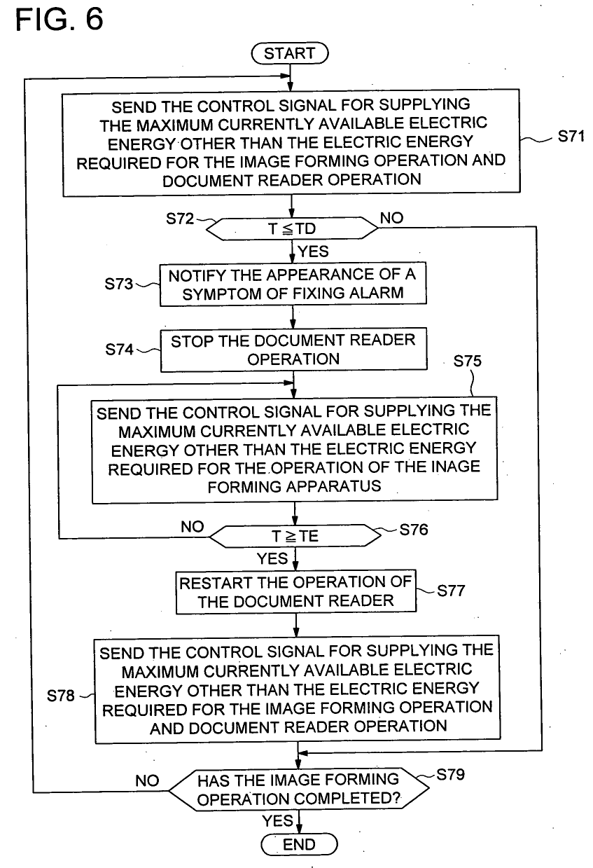

Referring to FIG. 6, the following describes the electric power control when a symptom of the occurrence of fixing alarm has been observed.

FIG. 6 is a flow chart representing the processing of electric power control when a symptom of the occurrence of fixing alarm has been confirmed. In FIG. 6, the processing is performed by the sub-controller 17. It is assumed that the present processing starts from the standby mode shown in FIG. 2.

The document is scanned by the document reader 14 and an instruction is given by-the operating section 11 to perform such operations as taking a copy (hereinafter referred to as “image forming operation”). Then the control signal for supplying the maximum currently available electric energy other than the electric energy required for the image forming operation and document reader operation (e.g. 900 W) is sent to the IH power supply unit 25 (Step S71). The power in response to this control signal is supplied to the fixing device 18 from the IH power supply unit 25.

This is followed by the decision step of determining whether or not the temperature T of the fixing roller 181 is below the fixing alarm symptom temperature TD. If it is determined that the temperature T is above the fixing alarm symptom temperature TD (NO in Step 72), the system goes to Step S79. Here it is assumed that the relationship among the fixing alarm symptom temperature TD, fixing alarm temperature TB and predetermined temperature TZ is expressed as TB<TD<TZ, wherein TD=TB+ΔT (ΔT>0). It is preferred that the fixing alarm symptom temperature TD should allow a normal toner image to be fixed on the recording material A.

If it is determined in Step S72 that the temperature T of the fixing roller 181 is below the fixing alarm symptom temperature TD (YES in Step 72), the display screen of the operating section 11 indicates a message to notify that the symptom of the occurrence of fixing alarm has been confirmed (Step S73). In this case, the execution of the image forming operation continues.

The scanning operation of the document reader 14 is stopped (Step S74) and the control signal for supplying the maximum currently available electric energy other than the electric energy required for the image forming operation (e.g. 1000 W) is sent to the IH power supply unit 25 (Step S75).

This is followed by the decision step of determining whether or not the temperature T of the fixing roller 18 has reached the predetermined temperature TE. If it is determined that the temperature T has reached the predetermined temperature TE (NO in Step S76), the system goes to Step S75. Here it is assumed that the relationship between the fixing alarm symptom temperature TD and predetermined temperature TE is expressed as TD<TE, wherein TE=TZ.

If it has been determined in Step S76 that it has reached the predetermined temperature TE (YES in Step S76), the scanning operation of the document reader 14 restarts (Step S77), and the control signal for supplying the maximum currently available electric energy other than the electric energy required for the image forming operation and scanning operation of the document reader (e.g. 900 W) is sent to the IH power supply unit 25 (Step S78).

Then a decision step is taken to determine whether or not the image forming operation has completed. If it is determined that this operation has not completed (NO in Step S79), the system goes back to Step S71. If it is determined that this operation has completed (YES in Step S79), the present processing completes.

As described above, during the time period from the appearance of a symptom of fixing alarm prior to occurrence of fixing alarm to the recovery to activation of the image formation mode where correct fixing of a toner image on the recording material A is enabled, the maximum available electric energy is supplied to the fixing device 18 by the sub-controller 17. This arrangement reduces the time for activation of the image formation mode. The operation of the document reader 14 is stopped by the sub-controller 17. This allows the electric energy for the operation of the document reader to be supplied to the fixing device 18. Further, the image forming operation is allowed to continue, whereby effective image forming operation can be performed. The sub-controller 17 recovers the normal state from the abnormal state where a symptom of fixing alarm appears prior to occurrence of fixing alarm. This arrangement prevents occurrence of fixing alarm wherein normal fusing operation is disabled.

The details of the structure and operations of the image forming apparatus 10 in the aforementioned embodiments can be modified as appropriate, without departing from the spirit of the present invention.

For example, electromagnetic induction heaters (first heater 182 and second heater 183) are used as the heaters of the fixing device 18 in the aforementioned embodiments. Without being restricted thereto, a halogen heater or ceramic heater can be used.

In the present embodiment, during the time period from the appearance of a symptom of fixing alarm prior to occurrence of fixing alarm to the recovery to activation of the image formation mode where correct fixing of a toner image on the recording material A is enabled, the maximum available electric energy is supplied to the electromagnetic induction heater by the electric power supply controller. This arrangement reduces the time for activation of the image formation mode. The operation of the document reader is stopped by the electric power supply controller. This allows the electric energy for the operation of the document reader to be supplied to the electromagnetic induction heater. Further, the image forming operation is allowed to continue, whereby effective image forming operation can be performed. The sub-controller recovers the normal state from the abnormal state where a symptom of fixing alarm appears prior to occurrence of fixing alarm. This arrangement prevents occurrence of fixing alarm wherein normal fusing operation is disabled.

In all of the aforementioned embodiments, a plurality of heaters can be installed at the center and ends of the fixing roller. Alternate on/off operations of these heaters ensures heating to be provided uniformly over the entire fixing roller. This eliminates the need of distributing electric power over a plurality of heaters.

It is to be noted that various changes and modifications will be apparent to those skilled in the art. Therefore, unless such changes and modifications depart from the scope of the present invention, they should be construed as being included therein.

What is claimed is:

1. An image forming apparatus comprising:
a fixing device to fix a toner image on a recording material;
an electric power source to supply to an electric power;
an electromagnetic induction heater, to which an electric power is supplied from the electric power source, to heat the fixing device by electromagnetic induction heating;
a starting controller to control starting of the image forming apparatus; and
a power supply controller which supplies available electric power from the power electric power source to the heater during the starting time of the image forming apparatus.

2. An image forming apparatus of claim 1, wherein the power supply control device supplies all available electric power other than the electric power for starting during the starting time to the heater.

3. The image forming apparatus of claim 1, further comprising a DC power supply source for converting the electric power received from said electric power source into the DC power, wherein the electric power that can be supplied from said electric power source does not include the electric power supplied to said DC power supply source.

4. The image forming apparatus of claim 1, wherein said power supply controller supplies said electromagnetic induction heater with electric power, other than the electric power required for said initialization, that can be supplied from said electric power source, when said image forming apparatus is initialized.

5. The image forming apparatus of claim 1, wherein said power supply controller supplies said electromagnetic induction heater with the electric power, other than the electric power required for process correction, which can be supplied from the electric power source, when said process correction is performed.

6. The image forming apparatus of claim 1, wherein said power supply controller stops supply of electric power from the electric power source, when the temperature of the electromagnetic induction heater has reached a predetermined level.

7. The image forming apparatus of claim 1, wherein said fixing device comprises a fixing roller and said electromagnetic induction heater comprises a center heater for heating the center of the fixing roller and an end heater for heating the end portion, wherein said power supply controller provides on/off control of said end heater and center heater on-an alternate basis.

8. An image forming apparatus comprising:
a fixing device for fixing a toner image formed on a recording material; an electric power source to supply to an electric power;
an electromagnetic induction heater for heating said fixing device through electromagnetic induction heating, using the electric power supplied from the-electric power source;
a temperature detector for detecting the temperature of said fixing device;
a document reader; and
a power supply controller for suspending the image forming operation and the document reader operation, before the temperature of said fixing device having been reduced by jamming reaches a predetermined level that allows normal fixing of said toner image, wherein said power supply controller supplies the electromagnetic induction heater with the maximum electric power that can be supplied from the electric power source.

9. The image forming apparatus of claim 8, wherein all electric power that can be supplied from the electric power source is supplied to said electromagnetic induction heater during the aforementioned time period.

10. The image forming apparatus of claim 8, further comprising a DC power supply source for converting the electric power received from said electric power source into the DC power, wherein the electric power that can be supplied from said electric power source other than electric power supplied to said DC power supply source.

11. The image forming apparatus of claim 8, wherein, when the temperature of the fixing device has reached a predetermined level, said electromagnetic induction heater is supplied with all available electric power other than the electric power required for the operation of said image reader.

12. The image forming apparatus of claim 8, wherein, when the temperature of said fixing device has reached the specified level higher than a predetermined temperature, the electromagnetic induction heater is supplied with all available electric power other than the electric power required for the operation of said image reader and image forming apparatus.

13. The image forming apparatus of claim 8, wherein said fixing device comprises a fixing roller and said electromagnetic induction heater comprises a center heater for heating the center of the fixing roller and an end heater for heating the end portion, wherein said power supply controller provides on/off control of said end heater and center heater on an alternate basis.

14. An image forming apparatus comprising:
a fixing device for fixing a toner image formed on a recording material;
an electric power source to supply to an electric power;
an electromagnetic induction heater for heating said fixing device through electromagnetic induction heating, using the electric power supplied from the electric power source;
a temperature detector for detecting the temperature of said fixing device;
a document reader;
a determining section for determining whether or not the temperature detected by the temperature detector has reached the fixing alarm generation temperature that disables the toner image fixing operation; and
a power supply controller that, when said determining section has determined that the temperature detected by the temperature detector has reached the fixing alarm generation temperature, suspends the image forming operation and the document reader operation, before the temperature of said fixing device having been detected by said temperature detector reaches a predetermined temperature that allows normal fixing of said toner image, wherein said power supply controller supplies the electromagnetic induction heater with the maximum electric power that can be supplied from the electric power source.

15. The image forming apparatus of claim 14, wherein all the electric power that can be supplied from the electric power source is supplied to said electromagnetic induction heater during the aforementioned time period.

16. The image forming apparatus of claim 14, further comprising a DC power supply source for converting the electric power received from said electric power source into the DC power, wherein the electric power that can be supplied from said electric power source other than electric power supplied to said DC power supply source.

17. The image forming apparatus of claim 14, wherein, when the temperature of the fixing device has reached a predetermined level, said electromagnetic induction heater is supplied with all available electric power other than the electric power required for the operation of said image reader.

18. The image forming apparatus of claim 14, wherein, when the temperature of said fixing device has reached the specified level higher than a predetermined temperature, the electromagnetic induction heater is supplied with all available electric power other than the electric power required for the operation of said image reader and image forming apparatus.

19. The image forming apparatus of claim 14, wherein said fixing device comprises a fixing roller and said electromagnetic induction heater comprises a center heater for heating the center of the fixing roller and an end heater for heating the end portion, wherein said power supply controller provides on/off control of said end heater and center heater on an alternate basis.

20. An image forming apparatus comprising:
a fixing device for fixing a toner image formed on a recording material;
an electric power source to supply to an electric power;
an electromagnetic induction heater for heating said fixing device through electromagnetic induction heating, using the electric power supplied from the electric power source;
a temperature detector for detecting the temperature of said fixing device;
a document reader;
a determining section for determining whether or not the temperature detected by the temperature detector is equal to the fixing alarm symptom temperature recorded immediately before the fixing alarm generation temperature that disables the toner image fixing operation; and
a power supply controller that, when said determining section has determined that said temperature detected by the temperature detector has reached the fixing alarm symptom temperature, suspends the document reader operation, before the temperature of said fixing device having been detected by said temperature detector reaches a predetermined temperature that allows normal fixing of said toner image, wherein said power supply controller supplies the electromagnetic induction heater with the maximum electric power that can be supplied from the electric power source.

21. An image forming apparatus of claim 20, wherein the electric power that can be supplied from said electric power source does not include the electric power required for the operation of the image reader.

22. The image forming apparatus of claim 20, wherein, when the temperature of the fixing device has reached a predetermined level, said electromagnetic induction heater is supplied with all available electric power other than the electric power required for the operations of said image reader and image forming apparatus.

23. The image forming apparatus of claim 20, further comprising a fixing roller, wherein said electromagnetic induction heater comprises a center heater for heating the center of the fixing roller and an end heater for heating the end portion, wherein said power supply controller provides on/off control of said end heater and center heater on an alternate basis.
